(19) United States
(12) Patent Application Publication
(10) Pub. No.: US 2025/0004725 A1
(43) Pub. Date: Jan. 2, 2025

(54) IMPROVED TRANSFORMERS USING FAITHFUL POSITIONAL ENCODING

(71) Applicant: International Business Machines Corporation, Armonk, NY (US)

(72) Inventors: Tsuyoshi Ide, Harrison, NY (US); Pin-Yu Chen, White Plains, NY (US)

(21) Appl. No.: 18/216,671

(22) Filed: Jun. 30, 2023

(51) Int. Cl. G06F 7/74; G06F 17/14

(52) U.S. Cl. CPC G06F 7/74; G06F 17/141

(57) ABSTRACT

In a method of machine learning inferencing, access, via a computer, raw data including data elements; and produce, via the computer, a respective positional encoding vector for each of the data elements. The producing includes computing coefficients using a discrete functional transform on a sequence of the data elements in the raw data. Produce, via the computer, one or more representational encoding vectors based upon the positional encoding vectors and that represent the raw data. Input via the computer, the one or more representational encoding vectors into a neural network. In response to the inputting, receive, via the computer, output from the neural network. The output includes an inference related to the raw data.

### BACKGROUND

The present invention relates generally to the electrical, electronic and computer arts and, more particularly, to machine learning and transformers for machine learning.

### BRIEF SUMMARY

Principles of the invention provide systems and techniques for improved transformers using faithful positional encoding. In one aspect, an exemplary method of machine learning inferencing includes the operations of accessing, via a computer, raw data comprising data elements; producing, via the computer, a respective positional encoding vector for each of the data elements, the producing comprising computing coefficients using a discrete functional transform on a sequence of the data elements in the raw data; producing, via the computer, one or more representational encoding vectors based upon the positional encoding vectors and that represent the raw data; inputting, via the computer, the one or more representational encoding vectors into a neural network; and in response to the inputting, receiving, via the computer, output from the neural network, the output comprising an inference related to the raw data.

In one aspect, a computer program product comprises one or more tangible computer-readable storage media and program instructions stored on at least one of the one or more tangible computer-readable storage media, the program instructions executable by a processor to cause the processor to: access raw data comprising data elements; produce a respective positional encoding vector for each of the data elements, the producing comprising computing coefficients using a discrete functional transform on a sequence of the data elements in the raw data; produce one or more representational encoding vectors based upon the positional encoding vectors and that represent the raw data; input the one or more representational encoding vectors into a neural network; and in response to the inputting, receive output from the neural network, the output comprising an inference related to the raw data.

In one aspect, an apparatus comprises a memory and at least one processor, coupled to the memory, and operative to perform operations comprising accessing raw data comprising data elements; producing a respective positional encoding vector for each of the data elements, the producing comprising computing coefficients using a discrete functional transform on a sequence of the data elements in the raw data; producing one or more representational encoding vectors based upon the positional encoding vectors and that represent the raw data; inputting the one or more representational encoding vectors into a neural network; and in response to the inputting, receiving output from the neural network, the output comprising an inference related to the raw data.

As used herein, “facilitating” an action includes performing the action, making the action easier, helping to carry the action out, or causing the action to be performed. Thus, by way of example and not limitation, instructions executing on a processor might facilitate an action carried out by instructions executing on a remote processor, by sending appropriate data or commands to cause or aid the action to be performed. Where an actor facilitates an action by other than performing the action, the action is nevertheless performed by some entity or combination of entities.

These and other features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1A is a high-level block diagram of a transformer for which positional encoding according to the described embodiments is implemented in an example embodiments;

FIG. 1B is a flowchart for a first example positional encoding method, in accordance with an example embodiment;

FIG. 1C is a flowchart for a second example positional encoding method, in accordance with an example embodiment;

FIGS. 2A and 2B show the distribution of the DFT encoding in the Fourier domain, in accordance with example embodiments;

FIG. 3 shows the results of reconstruction, in accordance with example embodiments;

FIG. 4 is a table showing a comparison between the original PE and DFT PE in a time-series classification task on three conventional benchmark data sets, in accordance with example embodiments;

FIG. 5 depicts a computing environment according to an embodiment of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

In general, a positional encoding system and methods for a transformer neural network architecture are disclosed. Unlike the standard sinusoidal positional encoding, example embodiments are based on solid mathematical ground and have a guarantee of not losing information of the positional order of the input sequence. Although previous works have reported promising results in their settings, their justification boils down to the empirical evaluation on specific datasets chosen. The use of multiple datasets should enhance objectivity to some extent, but finite data sets can never cover the entire world. We have found that exemplary embodiments of an inventive positional encoding approach systematically improve the prediction performance in the time-series classification task.

A new notion of faithfulness is introduced and a new PE is derived in a principled way as a solution that meets the faithfulness property. PE is thought of as a mapping from a localized position function (a.k.a. one-hot vector) to a smoother differentiable function. If there exists an inverse mapping, the PE holds full information of the position function, and hence, can be said to be faithful. A new PE method, called the discrete Fourier transform (DFT) encoding, that meets the faithfulness requirement. We have found that exemplary embodiments of the newly developed faithful PE improve the classification task performance.

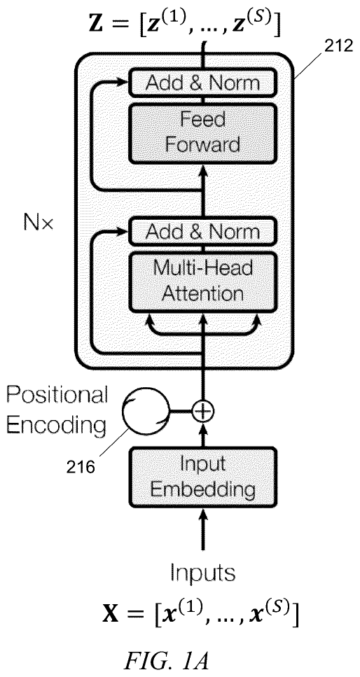

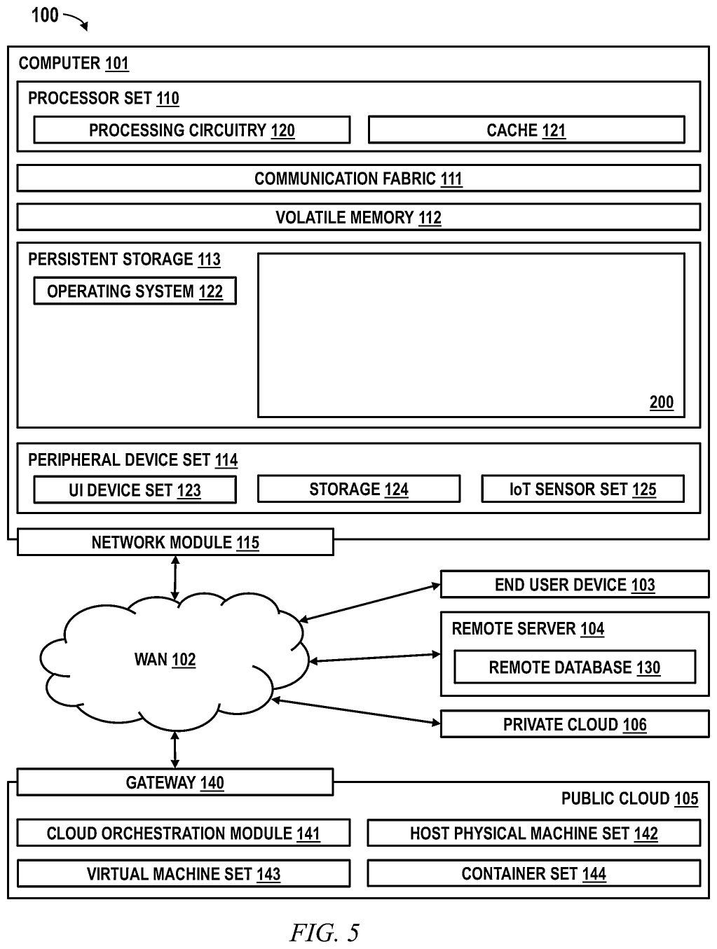

According to an aspect of the invention, there is provided a method of machine learning inferencing, including accessing, via a computer, raw data comprising data elements (Refer to operation 232 in FIG. 1B). The method further includes producing, via the computer, a respective positional encoding vector for each of the data elements. The producing includes computing coefficients using a discrete functional transform on a sequence of the data elements in the raw data. Refer, for example, to the section entitled DFT Positional Encoding. The method still further includes producing, via the computer, one or more representational encoding vectors based upon the positional encoding vectors and that represent the raw data. Refer, for example, to Z in FIG. 1A with the positional encoding 216 employing techniques disclosed herein. The method still further includes inputting, via the computer, the one or more representational encoding vectors into a neural network; and, in response to the inputting, receiving, via the computer, output from the neural network. The output includes an inference related to the raw data. The encoding and the neural network can be on the same or different machines. FIG. 5 shows an exemplary computer with elements that can facilitate the input and receiving steps.

It will thus be appreciated that, while it has been known to use a transformer in the field of neural networks to convert raw data to richer data, and to employ positional encoding to blend in the information of the order to the raw representation, the method set forth above provides improved positional encoding vectors based on a solid mathematical ground and having a guarantee of not losing information of the positional order of the input sequence.

In one or more embodiments, the discrete functional transform is a Fourier transform. More generally, the discrete functional transform can be selected from the group consisting of a Fourier transform, a discrete sine transform, a discrete cosine transform, a discrete Chebyshev transform, a Z-transform, a discrete Hartley transform, and a Hadamard transform.

In embodiments, the method further includes setting a local function ƒ^{(s)}(·) for s=0, . . . , d−1 (refer, for example, to operation 264 in FIG. 1C) and computing an expansion coefficient of ƒ^{(s)}(·) on a complete discrete basis set {ϕ₀, . . . , ϕ_{d-1}} with a sequence length d (refer, for example, to operation 268 in FIG. 1C). In this aspect, the producing of the positional encoding vector is carried out by arranging the computed expansion coefficients as a vector (refer, for example, to operation 272 in FIG. 1C). This aspect helps to provide the technological benefit of faithfulness.

In embodiments, in the step of producing the positional encoding vector, the corresponding positional encoding vector is represented by e^{(s)} and is based on: e^{(s)} [symbol] (a₀^{(s)}, a₁^{(s)}, . . . , b₁^{(s)}, . . . , b_{K}^{(s)}, b₀^{(s)})^{T}, where a₀^{(s)}, a₁^{(s)}, . . . , b₁^{(s)}, . . . , b_{K}^{(s)}, b₀^{(s)}) are coefficients of the corresponding positional encoding vector. This aspect helps to provide the technological benefit of faithfulness.

In embodiments, each corresponding positional encoding vector has a count of elements equal to a sequence length, d, of the raw data and K is set to (d/2)−1.

In embodiments, the sequence of raw data comes from one or more sensors; this aspect has the technological benefit of applying the improved positional encoding vectors to various physical systems that can be characterized by the sensor measurements.

In embodiments, the inferencing is a times-series classification; this aspect has the technological benefit of applying the improved positional encoding vectors to systematically improve the prediction performance in time-series classification tasks, thereby improving the technological process of computerized machine learning for a variety of applications.

In embodiments, the inferencing predicts an anomalous event of an elevator system; this aspect has the technological benefit of enhancing elevator safety and/or maintenance.

In embodiments, the inferencing includes natural language processing, including, for example, speech recognition and/or text-to-speech transformation; this aspect has the technological benefit of enhancing these areas with the improved positional encoding vectors.

### Preliminary

One or more embodiments provide machine learning models, such as transformers, that extract the feature vector set for an input sequence using a faithful positional encoding method. A faithful positional encoding method is a particular data processing method that takes the position index, such as s, of the input sequence as the input and produces a vector representation of the position as the output, where:
the vector representation is obtained as the vector of the coefficients of the expansion of a local function at s by the basis functions of a complete discrete basis set;
the local function is any local function (Gaussian distribution, Laplace distribution, Cauchy distribution, and the like) defined on a finite lattice on which the input sequence is defined; and
the complete discrete basis set is any complete discrete basis set, such as the Walsh-Hadamard Transform Basis, the Haar Wavelet Basis, and other Haar Wavelet Bases. In one example embodiment, the local function is the discrete delta function (or Kronecker's delta function). In one example embodiment, the complete discrete basis set is the discrete Fourier basis.

In one example embodiment, anomaly diagnosis for noisy multivariate sensor signals is performed. This is a notoriously challenging task with conventional methods. One of the major reasons is that it is not known upfront what spatial and temporal scales are relevant to the anomalies of interest. Some failures may be characterized by high-frequency jitters, while others may be due to relatively long-term shifts of certain signals. In addition, some failures may be detected as an outlier of a single sensor, while other failures may involve multiple sensors. The key technical challenge in anomaly diagnosis is to automatically learn the higher-order interactions between the temporal and spatial indices inherent in the multi-sensor data.

For instance, consider an anomaly diagnosis task for an elevator performed using sensor signals, such as angular and lateral accelerations, the tension of the cabin's cable, the velocity of the cabin, and the like. Each of those sensor signals can be viewed as a sequence and, hence, the self-attention weights can be defined based on the transformer model. If a transformer model is trained to classify between normal and abnormal elevator journeys using the disclosed positional encoding method, the self-attention weights provide useful information on which part of the sequence in time contributed the most to the detected anomaly.

The following section provides a summary of the original Transformer algorithm and the basics of discrete Fourier transform (DFT), which plays a pertinent role in deriving the proposed PE approach.

As introduced in the previous section, a pertinent goal in one or more embodiments of the Transformer algorithm is to “transform” an input vector sequence to another sequence of enriched representation vectors. It is assumed that the input sequence has S items, and each of the items has a raw data representation vector. An item can be, for example, a word or a time-series segment, and the representation vector can be, for example, the one-hot vector of a word or a vector of observed values in a time-series segment.

The raw data representation (such as word embeddings) is denoted by x^{(s)}∈ [symbol] ^{D} and the enriched representation (such as enriched embeddings) by z^{(s)}∈ [symbol] ^{D} for s=1, . . . , S. FIG. 1A is a high-level block diagram of a transformer 212 (using updated positional encoding according to aspects of the invention at 216). The transformer 212 can be viewed also as a transformation from an input data matrix of raw data representation vectors X [symbol] [x⁽¹⁾, . . . , x^{(s)}]∈ [symbol] ^{D×S} into another data matrix of new data representation vectors Z [symbol] [z⁽¹⁾, . . . , z^{(s)}]∈ [symbol] ^{d×S}. The motivation behind this transformation is to obtain a richer representation that captures not only the information of the word itself but also the dependency between the words. In other words, z^{(s)} carries information not only about the s-th words but also the other words that are semantically related. In a time-series example, x^{(t)} is a raw time-series segment as a vector, z^{(t)} is an embedding vector representing the t-th segment, and the results are used in a downstream task, such as forecasting.

In what follows, d is assumed to be even; however, extension to the case where d is odd will be straightforward for the skilled artisan, given the teachings herein. In the example, all the vectors are column vectors and are denoted in bold italic. Matrices are denoted in bold face, upper case letter.

### The Transformer Algorithm

The Transformer algorithm includes two steps: positional encoding (PE) and self-attention filtering.

### Positional Encoding

The goal of PE, in one or more embodiments, is to reflect the information of the position of the items (for example, words in machine translation) in the input sequence. In the original formulation, this was done by simply adding an extra vector to the raw representation vector of an input word:

$${x}^{( s )} ← {x}^{( s )} + {e}^{( s )} , \qquad ( 1 )$$

where x^{(s)} is the raw representation vector of the s-th item and e^{(s)} is its corresponding positional encoding vector 216, for example,

$${e}^{( s )} = {\tilde{e}}^{( s )} {=}^{Δ} {( sin ( {w}_{0} s ) , cos ( {w}_{0} s ) , sin ( {w}_{2} s ) , cos ( {w}_{2} s ) , … , sin ( {w}_{d - 2} s ) , cos ( {w}_{d - 2} s ) , )}^{⊤} \qquad ( 2 )$$

$$where$$

$${w}_{k} {=}^{Δ} {ρ}^{- \frac{k}{d}} , k = 0 , 2 , 4 , … , d - 2. \qquad ( 3 )$$

In one conventional technique, ρ is a hard-coded parameter, and ρ=10000 and d=512 were chosen (possibly through empirical results out of a few candidate values). This specific sinusoidal form seems to have been based on an intuition to capture different length scales of word-word dependency.

FIG. 1B is a flowchart for a first example positional encoding method, in accordance with an example embodiment. In one example embodiment, the input 232 to the positional encoding method includes the sequence length d and K, which is set to (d/2)−1). For s=0, . . . , d−1, a₀^{(s)}, . . . , a_{K}^{(s)} and b₀^{(s)}, . . . , b_{K}^{(s)} are computed using equations (17)-(20) (operation 236), the corresponding positional encoding vector e^{(s)} is determined using equation (21) (operation 240), and the positional encoding vector e^{(s)} is output (operation 244).

FIG. 1C is a flowchart for a second example positional encoding method, in accordance with an example embodiment. In one example embodiment, the input 260 to the positional encoding method includes the sequence length d, K is set to (d/2)−1, and a complete discrete basis set {ϕ₀, . . . , ϕ_{d-1}}. For s=0, . . . , d−1, a local function is ƒ^{(s)}(·) is set (operation 264), the expansion coefficient of ƒ^{(s)}(·) is computed on {ϕ₀, . . . , ϕ_{d-1}} (operation 268), and the corresponding positional encoding vector e^{(s)} is determined by arranging the coefficients as a vector (operation 272), and the positional encoding vector e^{(s)} is output (operation 276).

### Self-Attention Filtering

With Eq. (1), an updated data matrix X is attained. The self-attention filtering further updates X to obtain Z. There are three steps in the exemplary algorithm. The first step is to create three different feature vectors from X:

$$Q {=}^{Δ} {W}_{Q} X , K {=}^{Δ} {W}_{K} X , V {=}^{Δ} {W}_{V} X , \qquad ( 4 )$$

which are called the query, key, and value, respectively. The matrices W_{Q}, W_{K}, W_{V} are d×D and are to be learned from data. Denote the column vectors as Q=[q⁽¹⁾, . . . , q^{(S)}], K=[k⁽¹⁾, . . . , k^{(S)}], and V=[v⁽¹⁾, . . . , v^{(S)}]. Note that Q, K, V as well as X have been defined as column-based data matrices.

The second step is to compute the self-attention matrix A. From the query and key matrix, the self-attention matrix A∈ [symbol] ^{S×S} is defined as

$$A {=}^{Δ} softmax ( \frac{1}{\sqrt{d}} {Q}^{⊤} K ) , \qquad ( 5 )$$

where the softmax function applies to each row. To write down the (i,j) element explicitly:

$${A}_{i , j} = \frac{exp ( {B}_{i , j} )}{{\sum }_{m = 1}^{S} exp ( {B}_{i , m} )} , {B}_{i , j} {=}^{Δ} \frac{1}{\sqrt{d}} {( {q}^{( i )} )}^{⊤} {k}^{( j )} , \qquad ( 6 )$$

This definition implies that A is essentially a cosine-similarity matrix between the items i and j. Hence, if, e.g., A_{1,3} and A_{1,6} dominate the first row, the 3rd and 6th items can be viewed as item 1's neighbors.

Finally, the third step is to take in the influence of neighbors in each row:

$${z}^{( s )} = {\sum }_{k = 1}^{S} {A}_{s , k} {v}^{( k )} or Z = {VA}^{⊤} \qquad ( 7 )$$

Through this step, the representation vectors are encouraged to have similar values to their neighbors.

Typically, self-attention filtering is multiplexed by using multiple “heads.” (The term “head” seems to be originated from the Turing machine, where a head means a tape head to read magnetic tapes.) Let H be the number of heads. In this approach, H different sets of the parameter matrices are used {W_{Q}^{[h]}, W_{K}^{[h]}, W_{V}^{[h]}|h=1, . . . , H} with different initializations. As a result, H different self-attention matrices {A^{[h]}} and value vectors {v^{(s)[h]}=W_{V}^{[h]}x^{(s)}} are

$$\begin{matrix}{z}^{( s ) [ 1 ]} = {\sum }_{k = 1}^{S} {A}_{s , k}^{[ 1 ]} {v}^{( k ) [ 1 ]} , … , {z}^{( s ) [ H ]} = {\sum }_{k = 1}^{S} {A}_{s , k}^{[ H ]} {v}^{( k ) [ H ]} & ∈ {ℝ}^{d}\end{matrix} \qquad ( 8 )$$

The final representation is created simply by concatenating these H vectors as

$$\begin{matrix}{z}^{( 1 )} = ( \begin{matrix}{z}^{( 1 ) [ 1 ]} \\ ⋮ \\ {z}^{( 1 ) [ H ]}\end{matrix} ) , … , {z}^{( s )} = ( \begin{matrix}{z}^{( S ) [ 1 ]} \\ ⋮ \\ {z}^{( S ) [ H ]}\end{matrix} ) & ∈ {ℝ}^{dH}\end{matrix} \qquad ( 9 )$$

### Discrete Fourier Transform (DFT)

One or more embodiments of the Transformer algorithm are concerned with d-dimensional representation vectors representing the items in the sequence of length S. Finding a d-dimensional representation vector can be viewed as assigning a function defined on a one-dimensional lattice with d lattice points. This is a useful change of view, since a rich set of mathematical tools exist to study the expressiveness of functions. In this subsection, the basics of DFT, which plays a central role in the proposed DFT PE, are recapitulated.

It is well-known that any function ƒ(t) defined on the d-dimensional lattice t=0, 1, . . . , d−1 can be expanded with the discrete Fourier bases as

$$f ( t ) = \frac{1}{\sqrt{d}} [ {a}_{0} + {b}_{0} cos ( π t ) ] + \sqrt{\frac{2}{d}} {\sum }_{k = 1}^{K} ( {a}_{k} cos ( {ω}_{k} t ) + {b}_{k} sin ( {ω}_{k} t ) ) , \qquad ( 10 )$$

where it has been assumed that d is even and

$$\begin{matrix}K {=}^{Δ} \frac{d}{2} - 1 , & {ω}_{k}\end{matrix} {=}^{Δ} \frac{2 π k}{d} . \qquad ( 11 )$$

The expansion (10) defines a mapping from the function ƒ(t) to the set of coefficients {(aₗ, bₗ)|l=0, . . . , K}. This mapping is called the discrete Fourier transform (DFT). Notice that the total number of the terms is 2+2K=d. For notational simplicity, define:

$${φ}_{l} ( t ) {=}^{Δ} \{ \begin{matrix}\frac{1}{\sqrt{d}} & l = 0 \\ \sqrt{\frac{2}{d}} cos ( {ω}_{l} t ) & l = 1 , … , K \\ \sqrt{\frac{2}{d}} sin ( {ω}_{l} - {K}^{t} ) & l = K + 1 , … , 2 K \\ \frac{1}{\sqrt{d}} cos ( π t ) & l = d - 1\end{matrix}$$

It is straightforward to verify that this basis functions satisfy the orthogonality condition

$${\sum }_{t = 0}^{d - 1} {φ}_{l} ( t ) {φ}_{m} ( t ) = {δ}_{l , m} , \qquad ( 12 )$$

where δ_{l,m} is Kronecker's delta. The orthogonality of the Fourier bases allows straightforwardly finding the coefficients as

$$f ( t ) = {\sum }_{l = 0}^{d - 1} {c}_{l} {φ}_{l} ( t ) , where {c}_{l} = {\sum }_{t = 0}^{d - 1} f ( t ) {φ}_{l} ( t ) . \qquad ( 13 )$$

In terms of aₗs and bₗs:

$${a}_{0} = {\sum }_{t = 0}^{d - 1} f ( t ) {φ}_{0} ( t ) , {b}_{0} = {\sum }_{t = 0}^{d - 1} f ( t ) {φ}_{d - 1} ( t ) , {a}_{l} = {\sum }_{t = 0}^{d - 1} f ( t ) {φ}_{l} ( t ) , {b}_{l} = {\sum }_{t = 0}^{d - 1} f ( t ) {φ}_{l + k} ( t ) \qquad ( 14 )$$

for l=1, . . . , K.

One of the most remarkable properties of DFT is that DFT is invertible. In the DFT expansion (13), the function values ƒ [symbol] (ƒ(0), . . . , ƒ(d−1))^{T} can be fully recovered by c [symbol] (c₀, . . . , c_{d-1})^{T}, given the DFT bases. In other words, c and ƒ have exactly the same information; one can think of {cₗ} as another representation of ƒ(t).

### Fourier Analysis of Positional Encoding

In the following section, it is discussed how Fourier analysis is used to evaluate the goodness of positional encoding 216.

### Original PE has a Strong Low-Pass Property

Positional encoding includes the task of finding a d-dimensional representation vector of an item in the input sequence of length S. In the vector view, the position of the s-th item in the input sequence is most straightforwardly represented by an S-dimensional “one-hot” vector, whose s-th entry is 1 and otherwise 0. Unfortunately, this is not an appropriate representation because the dimensionality is fixed to be S, and it does not have continuity over the elements at all, which makes numerical optimization challenging in stochastic gradient descent.

The original PE is designed to eliminate these limitations:

$$\begin{matrix}{PE}_{( pos , 2 i )} = sin ( pos / {10000}^{2 i / {d}_{model}} ) \\ {PE}_{( pos , 2 i + 1 )} = cos ( pos / {10000}^{2 i / {d}_{model}} )\end{matrix}$$

Then, the question is how to tell the goodness of its specific functional form. One approach suggested by the sinusoidal form is to use DFT. As before, consider DFT on the 1-dimensional (1D) lattice with d lattice points. As shown in Eq. (10), any function is represented as a linear combination of the sinusoidal function with the frequencies {ωₖ}. It is interesting to see how the frequencies {ωₖ} in Eq. (3) are distributed in the Fourier space.

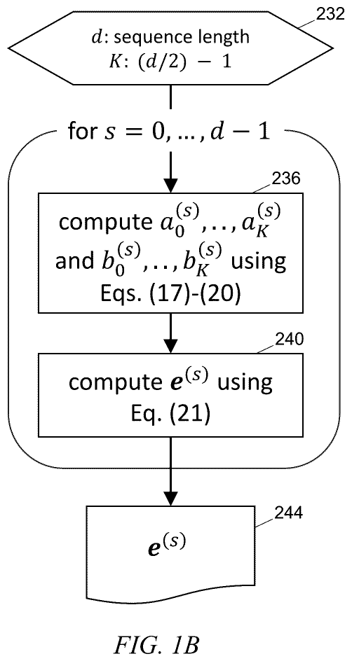

FIGS. 2A and 2B are graphs of the distribution of the frequency

$${ω}_{k} = {ρ}^{- \frac{k}{d}}$$

in Eq. (3) over the Fourier bases (solid line), where ρ=10000, d=256, in accordance with example embodiments. Notice the contrast to that of the DFT encoding, which gives a uniform distribution (dashed line; see section entitled “DFT Positional Encoding”). The solid line in FIGS. 2A and 2B show the distribution of the frequencies of Eq. (3). The distribution is estimated with the kernel density estimation with the Gaussian kernel. Specifically, at each ωₖ, the weight is given by

$${g}_{k} = {\sum }_{l ∈ \{ 0 , 2 , … , d - 2 \}} \frac{1}{R} exp ( - \frac{1}{2 {σ}^{2}} {( {ω}_{k} - {ω}_{l} )}^{2} ) , \qquad ( 15 )$$

where R is a normalization constant to satisfy Σₖ gₖ=1. The bandwidth

$$σ = 4 \times \frac{2 π}{d}$$

was chosen with d=256. Due to the power function

$${ρ}^{- \frac{k}{d}} ,$$

the distribution is extremely skewed towards zero.

This fact can also be understood by running a simple analysis as follows. The first and second smallest frequencies are 0, 2π/d, respectively. The number of ωₖs that fall into between them can be counted. Solving the equation:

$$\frac{2 π}{d} = {ρ}^{- \frac{l}{d}} \qquad ( 16 )$$

and assuming ρ=10000,

$$l = \frac{d}{4} {log}_{10} \frac{d}{2 π} \approx 103$$

for d=256 and l≈245 for d=512. Hence, almost a half of the entries go to this lowest bin.

This simple analysis, along with FIG. 2A, demonstrates that the original PE has a strong bias to suppress mid and high frequencies. As a result, it tends to ignore mid- and short-range differences in location. This can be problematic in applications where short-range dependencies matter, such as time-series classification for physical sensor data.

### Original PE Lacks Faithfulness

Another interesting question is what kind of function the skewed distribution gₖ represents. To answer this question, an experiment described in Algorithm 1 was performed, which is designed to understand what kind of distortion the original PE may introduce to an assumed reference function. In the present PE context, the reference function should be the position function (a.k.a. one-hot vector) since the original PE (2) was proposed to be a representation of the item at the location s.

Algorithm 1: Reference function reconstruction

| Require: Reference function f (t), DFT component weights {gₖ}. | |
|---|---|
| 1: | Find DFT coefficients of f as {(aₖ, bₖ) \| k = 0,..., K}. |
| 2: | a₀ ← a₀g(ω₀) and b₀ ← b₀g(ω_{K+1}) |
| 3: | for all k = 1,..., K do |
| 4: | aₖ ← aₖgₖ and bₖ ← bₖgₖ |
| 5: | end for |
| 6: | Inverse-DFT from the modified coefficients. |

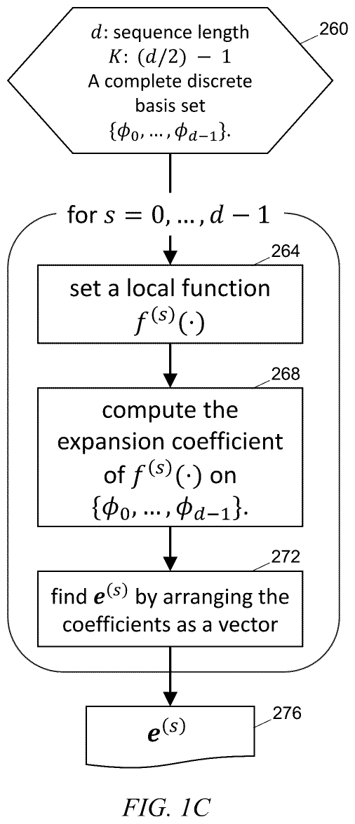

FIG. 3 shows the results of reconstruction, in accordance with example embodiments. The modified DFT coefficients are normalized so the original [symbol] ₂ norm is kept unchanged. All the parameters used are the same as those in FIG. 2A, i.e., d=256, S=80, h=10000,

$$σ = 4 \times \frac{2 π}{d} .$$

As expected from the low-pass property, the reconstruction by the original PE failed to reproduce the delta functions. The broad distributions imply that the original PE is not sensitive to the difference in the location up to about 30. As the total sequence length is S=80, it is concluded that the original PE tends to put an extremely strong emphasis on global long-range dependencies within the sequence.

If the PE is supposed to get a representation of the position function, PE should faithfully reproduce the original position function. Here, the notion of the faithfulness of PE is formally defined as:

Definition 1 (Faithfulness of PE). A positional encoding is said to be faithful if it is injective (i.e., one-to-one) to the position function.

For PE, the requirement of faithfulness seems natural. It would be helpful to find positional encoding that better fulfills this requirement of faithfulness.

### DFT Positional Encoding

For the requirement of faithfulness, one straightforward approach is to leverage DFT for positional encoding. The idea is to use the DFT representation as a smooth surrogate for the one-hot function ƒₛ(t) [symbol] δ_{s,t}. Let a₀^{(s)}, a₁^{(s)}, . . . , b₁^{(s)}, . . . , b_{K}^{(s)}, b₀^{(s)} be the DFT coefficients of ƒₛ(t). It is straightforward to compute the coefficients against the real Fourier bases:

$${a}_{0}^{( s )} = {\sum }_{t = 0}^{d - 1} {δ}_{s , t} {φ}_{0} ( t ) = {\sum }_{t = 0}^{d - 1} {δ}_{s , t} \frac{1}{\sqrt{d}} = \frac{1}{\sqrt{d}} \qquad ( 17 )$$

$${a}_{1}^{( s )} = {\sum }_{t = 0}^{d - 1} {δ}_{s , t} {φ}_{1} ( t ) = {\sum }_{t = 0}^{d - 1} {δ}_{s , t} \sqrt{\frac{2}{d}} cos ( {ω}_{1} t ) = \sqrt{\frac{2}{d}} cos ( {ω}_{1} s ) \qquad ( 18 )$$

$$⋮$$

$${b}_{K}^{( s )} = {\sum }_{t = 0}^{d - 1} {δ}_{s , t} {φ}_{K} ( t ) = {\sum }_{t = 0}^{d - 1} {δ}_{s , t} \sqrt{\frac{2}{d}} sin ( {ω}_{K} t ) = \sqrt{\frac{2}{d}} sin ( {ω}_{K} s ) \qquad ( 19 )$$

$${b}_{0}^{( s )} = {\sum }_{t = 0}^{d - 1} {δ}_{s , t} {φ}_{d - 1} ( t ) = {\sum }_{t = 0}^{d - 1} {δ}_{s , t} \sqrt{\frac{1}{d}} cos ( π t ) = \sqrt{\frac{1}{d}} cos ( π s ) \qquad ( 20 )$$

which provides the vector representation of the one-hot function as

$${e}^{( s )} {=}^{Δ} {( {a}_{0}^{( s )} , {a}_{1}^{( s )} , … , {b}_{1}^{( s )} , … , {b}_{K}^{( s )} , {b}_{0}^{( s )} )}^{⊤} \qquad ( 21 )$$

Equation (21) is called the DFT encoding herein.

Theorem 1. The DFT encoding is faithful.

(Proof) This follows from the existence of inverse transformation in DFT. This can be proven directly. By using Eq. (21), the right-hand side (r.h.s.) of the DFT expansion in Eq. (10) will be

$$r . h . s = \frac{1}{d} [ 1 + cos ( π t ) cos ( π s ) ] + \frac{2}{d} {\sum }_{k = 1}^{K} [ cos ( {ω}_{k} s ) cos ( {ω}_{k} t ) + sin ( {ω}_{k} s ) sin ( {ω}_{k} t ) ] = \frac{1}{d} [ 1 + {( - 1 )}^{s - t} ] + \frac{2}{d} {\sum }_{k = 1}^{K} cos ( {ω}_{k} ( s - t ) )$$

It can be seen that the r.h.s. is 1 if s=t. Now, assume s≠t. Using

$$cos x = \frac{1}{2} ( {e}^{ix} + {e}^{- ix} )$$

and the sum rule of geometric series:

$$r . h . s = \frac{1}{d} [ 1 + {( - 1 )}^{s - t} ] + \frac{1}{d} [ \frac{{c}_{s , t} - {c}_{s , t}^{K + 1}}{1 - {c}_{s , t}} + \frac{{c}_{s , t}^{- 1} - {c}_{s , t}^{- K - 1}}{1 - {c}_{s , t}^{- 1}} ] = \frac{1}{d} [ 1 + {( - 1 )}^{s - t} ] + \frac{1}{d} \frac{{c}_{s , t} - {c}_{s , t}^{K + 1} - 1 + {c}_{s , t}^{- K}}{1 - {c}_{s , t}}$$

where

$${c}_{s , t} {=}^{Δ} exp ( i \frac{2 π ( s - t )}{d} ) .$$

Noting c_{s,t}^{-K-1}=c_{s,t} and c_{s,t}^{K+1}=(−1)^{s-t}:

$$r . h . s . = \frac{1}{d} [ 1 + {( - 1 )}^{s - t} ] - \frac{1}{d} [ 1 + {( - 1 )}^{s - t} ] = 0.$$

Putting all together, the inverse DFT of the DFT encoding gives δ_{s,t}, which is the location function.

FIGS. 2A and 2B show the distribution of the DFT encoding in the Fourier domain, in accordance with example embodiments. From Eqs. (17)-(20), the distribution can be seen as given by

$${g}_{k}^{DFT} = \frac{1}{d} ( {δ}_{k , 0} + {δ}_{k , d - 1} ) + \frac{2}{d} {\sum }_{l = 1}^{K} {δ}_{k , l} , \qquad ( 22 )$$

where δ_{k,0} etc. are Kronecker's delta function. This distribution is flat except for the terminal points at k=0, d−1. Hence, unlike the original PE, the proposed DFT PE does not have any bias on the choice of the Fourier components.

With this flat distribution, the reconstruction experiment was conducted. The result is shown in the bottom panel in FIG. 3. It is seen that the location functions are perfectly reconstructed with DFT PE.

### Experimental Evaluation

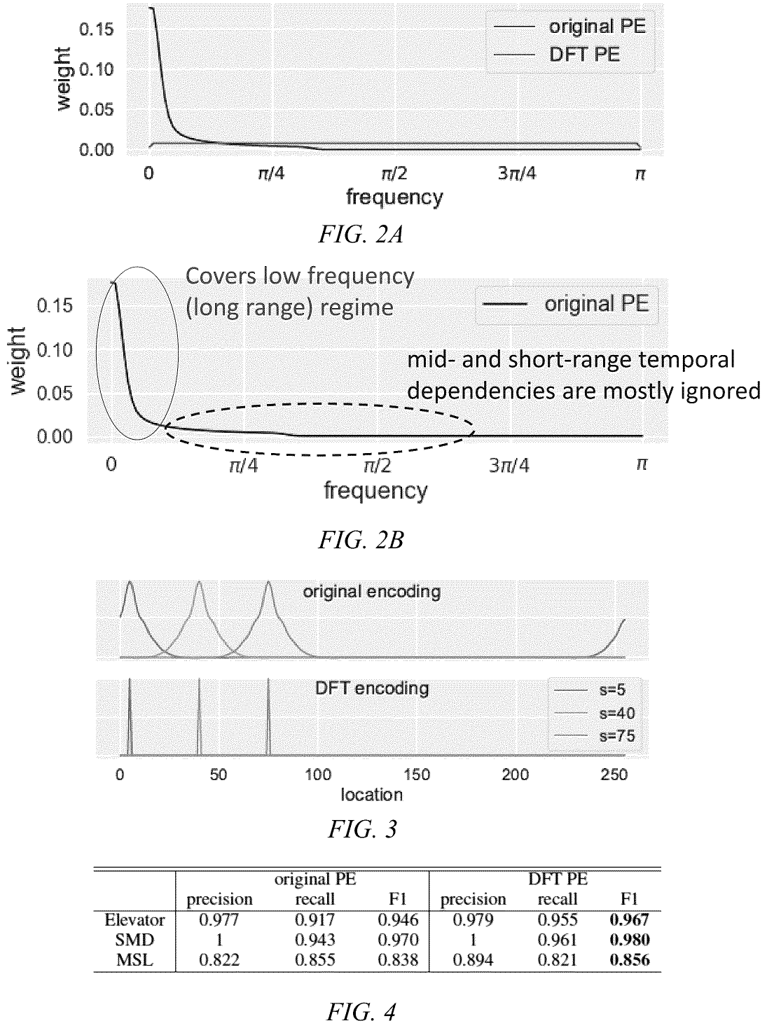

DFT PE was tested in a time-series classification task. The input is a multivariate time-series and the output is a binary label representing whether the input time-series is anomalous or not. Three conventional benchmark datasets were used. The result is summarized in the table of FIG. 4, where F1 is the harmonic average between the precision and the recall. FIG. 4 is a table showing a comparison between the original PE and DFT PE in a time-series classification task on three conventional benchmark data sets, in accordance with example embodiments. DFT PE gives systematically better performance.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
a positional encoding approach based on solid mathematical ground and having a guarantee of not losing information of the positional order of the input sequence; and
a positional encoding approach that systematically improves the prediction performance in time-series classification tasks, thereby improving the technological process of computerized machine learning for a variety of applications, including but not limited to predicting an anomalous event of an elevator system; carrying out natural language processing, speech recognition, or text-to-speech transformation, or the like.

Given the discussion thus far, it will be appreciated that, in general terms, an exemplary method, according to an aspect of the invention, includes the operations of accessing, by a computing device, the sequence of raw data; computing coefficients of a corresponding positional encoding vector, wherein each positional encoding vector has a count of elements equal to a length of the sequence of raw data (operation 236); determining the corresponding positional encoding vector (operation 240); imposing, using the neural network, a sequence structure on the sequence of raw data, the sequence structure using the positional encoding vector; outputting, by the computing device, a sequence of representational encoding vectors, the representational encoding vectors based upon the positional encoding vector; and utilizing, by the computing device, the representational encoding vectors to provide information on the sequence of raw data, wherein the computing device utilizing the representational encoding vectors to provide information on the sequence of raw data comprises carrying out inferencing based on the representational encoding vectors.

The inferencing can be, for example, a times-series classification. The inferencing could, for example, predict an anomalous event of an elevator system; include natural language processing; include speech recognition; or include text-to-speech transformation.

The sequence of raw data can come from one or more sensors such as accelerometers, position detectors, load cell, strain gauge, a microphone and acoustic front end, or the like, depending on the application. Sensor data can be gathered, for example, over WAN 102 discussed below, which could also be used to control the elevator via signals.

In one aspect, a computer program product comprises one or more tangible computer-readable storage media and program instructions stored on at least one of the one or more tangible computer-readable storage media, the program instructions executable by a processor, the program instructions comprising accessing the sequence of raw data; computing coefficients of a corresponding positional encoding vector, wherein each positional encoding vector has a count of elements equal to a length of the sequence of raw data (operation 236); determining the corresponding positional encoding vector (operation 240); imposing, using a neural network, a sequence structure on the sequence of raw data, the sequence structure using the positional encoding vector; outputting a sequence of representational encoding vectors, the representational encoding vectors based upon the positional encoding vector; and utilizing the representational encoding vectors to provide information on the sequence of raw data, wherein the utilizing the representational encoding vectors to provide information on the sequence of raw data comprises carrying out inferencing based on the representational encoding vectors.

In one aspect, an apparatus comprises a memory and at least one processor, coupled to the memory, and operative to perform operations comprising accessing the sequence of raw data; computing coefficients of a corresponding positional encoding vector, wherein each positional encoding vector has a count of elements equal to a length of the sequence of raw data (operation 236); determining the corresponding positional encoding vector (operation 240); imposing, using a neural network, a sequence structure on the sequence of raw data, the sequence structure using the positional encoding vector; outputting a sequence of representational encoding vectors, the representational encoding vectors based upon the positional encoding vector; and utilizing the representational encoding vectors to provide information on the sequence of raw data, wherein the utilizing the representational encoding vectors to provide information on the sequence of raw data comprises carrying out inferencing based on the representational encoding vectors.

Refer now to FIG. 5.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as transformer machine learning system 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of machine learning inferencing, the method comprising:
accessing, via a computer, raw data comprising data elements;
producing, via the computer, a respective positional encoding vector for each of the data elements, the producing comprising computing coefficients using a discrete functional transform on a sequence of the data elements in the raw data;
producing, via the computer, one or more representational encoding vectors based upon the positional encoding vectors and that represent the raw data;
inputting, via the computer, the one or more representational encoding vectors into a neural network; and
in response to the inputting, receiving, via the computer, output from the neural network, the output comprising an inference related to the raw data.

2. The method of claim 1, further comprising:
setting a local function ƒ^{(s)}(·) for s=0, . . . , d−1; and
computing an expansion coefficient of ƒ^{(s)}(·) on a complete discrete basis set {ϕ₀, . . . , ϕ_{d-1}} with a sequence length d;
wherein the producing of the positional encoding vector is carried out by arranging the computed expansion coefficients as a vector.

3. The method of claim 1, wherein, in the step of producing the positional encoding vector, each corresponding positional encoding vector is represented by e^{(s)} and is based on:
e^{(s)} [symbol] (a₀^{(s)},a₁^{(s)}, . . . ,b₁^{(s)}, . . . ,b_{K}^{(s)},b₀^{(s)})^{T},
where a₀^{(s)}, a₁^{(s)}, . . . , b₁^{(s)}, . . . , b_{K}^{(s)}, b₀^{(s)} are coefficients of the corresponding positional encoding vector.

4. The method of claim 3, wherein each corresponding positional encoding vector has a count of elements equal to a sequence length, d, of the raw data and wherein K is set to (d/2)−1.

5. The method of claim 1, wherein a sequence of the raw data comes from one or more sensors.

6. The method of claim 1, wherein the inference is a times-series classification.

7. The method of claim 1, wherein the inference predicts an anomalous event of an elevator system.

8. The method of claim 1, wherein the inference comprises natural language processing.

9. The method of claim 1, wherein the inference comprises speech recognition.

10. The method of claim 1, wherein the inference comprises text-to-speech transformation.

11. The method of claim 1, wherein the discrete functional transform is selected from the group consisting of a Fourier transform, a discrete sine transform, a discrete cosine transform, a discrete Chebyshev transform, a Z-transform, a discrete Hartley transform, and a Hadamard transform.

12. The method of claim 1, wherein the discrete functional transform is Fourier transform.

13. A computer program product, comprising:
one or more tangible computer-readable storage media and program instructions stored on at least one of the one or more tangible computer-readable storage media, the program instructions executable by a processor to cause the processor to:
access raw data comprising data elements;
produce a respective positional encoding vector for each of the data elements, the producing comprising computing coefficients using a discrete functional transform on a sequence of the data elements in the raw data;
produce one or more representational encoding vectors based upon the positional encoding vectors and that represent the raw data;
input the one or more representational encoding vectors into a neural network; and
in response to the inputting, receive output from the neural network, the output comprising an inference related to the raw data.

14. A system comprising:
a memory; and
at least one processor, coupled to said memory, and operative to perform operations comprising:
accessing raw data comprising data elements;
producing a respective positional encoding vector for each of the data elements, the producing comprising computing coefficients using a discrete functional transform on a sequence of the data elements in the raw data;
producing one or more representational encoding vectors based upon the positional encoding vectors and that represent the raw data;
inputting the one or more representational encoding vectors into a neural network; and
in response to the inputting, receiving output from the neural network, the output comprising an inference related to the raw data.

15. The system of claim 14, the operations further comprising:
setting a local function ƒ^{(s)}(·) for s=0, . . . , d−1; and
computing an expansion coefficient of ƒ^{(s)}(·) on a complete discrete basis set {ϕ₀, . . . , ϕ_{d-1}} with a sequence length d;
wherein the producing of the positional encoding vector is carried out by arranging the computed expansion coefficients as a vector.

16. The system of claim 14, wherein the producing of the corresponding positional encoding vector is represented by e^{(s)} and is based on:
e^{(s)} [symbol] (a₀^{(s)},a₁^{(s)}, . . . ,b₁^{(s)}, . . . ,b_{K}^{(s)},b₀^{(s)})^{T},
where a₀^{(s)}, a₁^{(s)}, . . . , b₁^{(s)}, . . . , b_{K}^{(s)}, b₀^{(s)} are coefficients of the corresponding positional encoding vector.

17. The system of claim 14, wherein a sequence of the raw data comes from one or more sensors.

18. The system of claim 14, wherein the inference is a times-series classification.

19. The system of claim 14, wherein the inference predicts an anomalous event of an elevator system.

20. The system of claim 14, wherein the inference comprises natural language processing.
